(19) United States
(12) Patent Application Publication
(10) Pub. No.: US 2012/0323482 A1
(43) Pub. Date: Dec. 20, 2012

(54) PROGRAM-STORING COMPUTER-READABLE STORAGE MEDIUM, COMPUTER PROGRAM PRODUCT, NAVIGATION DEVICE AND CONTROL METHOD THEREOF

(75) Inventor: Zheng-Ping Wu, Shanghai (CN)

(73) Assignees: MITAC RESEARCH (SHANGHAI) LTD., SHANGHAI (CN); MITAC INTERNATIONAL CORP., TAOYUAN COUNTY (TW)

(21) Appl. No.: 13/177,836

(22) Filed: Jul. 7, 2011

(30) Foreign Application Priority Data
Jun. 16, 2011 (CN) 201110162972.7

(51) Int. Cl. G01C 21/00

(52) U.S. Cl. 701/410; 701/450

(57) ABSTRACT

A navigation device includes a touch unit and a processing unit. The touch unit receives touches made thereon by a user with an object and correspondingly generates a plurality of touch points. The processing unit is electrically connected to the touch unit and uses a start location, a target location, the plurality of touch points, and an electronic map to generate a navigation route. A navigation device control method as well as a program-storing computer-readable storage medium and a computer program product enabling implementation of the control method are also disclosed.

### CROSS-REFERENCE TO RELAYED APPLICATION

This application claims the benefit under 35 U.S.C. §119 of Chinese Patent Application No. 201110162972.7, filed Jun. 16, 2011, which is hereby incorporated by reference in its entirety.

### BACKGROUND OF THE INVENTION

1. Field of the Invention

The present invention relates to a program-storing computer-readable storage medium, a computer program product, a navigation device and a control method thereof; and more particularly, to a navigation device and a control method thereof that uses a plurality of touch points generated corresponding to touches made on a touch unit by a user with an object as a basis to plan and generate a navigation route that passes through paths defined by the touch points.

2. Description of the Related Art

Currently, a prior art navigation system provides car navigation service by receiving Global Positioning System (GPS) real-time signals to determine the device's current location and using navigation software with map information. According to the most common way of navigation provided by the conventional navigation system, a user first sets a point of departure (i.e. a start location) and a destination (i.e. a target location), and the navigation system will utilize a built-in map database to automatically plan an optimal route for the user's reference and guide the user step by step to the correct direction, so that the user can successfully and smoothly arrive at the destination.

While there are various types of navigation systems available in the market to provide pretty good functions, such as click-type operating window and navigation route planning, these navigation systems still have some problems in practical operation thereof and accordingly, require improvements. For example, when a user wants to add avoided roads into the settings for route planning, the user has to first search for the roads to be avoided or click on the operating window to select one or more avoidance options, such as freeway, U-turn, or toll gate. And then, the navigation system adds the user-selected avoided roads or the user-selected avoidance options into a list of avoided paths before starting the planning of an optimal navigation route. However, in the case the user knows only the roads he or she wants to drive through but not the roads he or she should avoid, it would cause difficulty and inconvenience to the user in operating the navigation system.

Further, there is another way available in the market to avoid undesired roads. That is, the user is allowed to select one or more avoided areas and the navigation system uses the user-selected avoided areas as a basis to generate a navigation route that does not pass through the avoided areas. However, in the practical navigation process, there are times the user finds that the navigation route computed by the navigation system to avoid the undesired areas includes too many detours or is too complicated to drive through easily. Therefore, the use of the user-selected avoided areas as the basis to decide the avoided roads would indeed increase the complexity in the operation and navigation route planning of the navigation system, and this in turn reduces the user's interest in using the road avoidance function. It is therefore tried by the inventor to develop a program-storing computer-readable storage medium, a computer program product, a navigation device and a control method thereof that provide increased utility by overcoming the drawbacks existed in the prior art navigation systems.

### BRIEF SUMMARY

A primary object of the present invention is to provide a program-storing computer-readable storage medium, a computer program product, a navigation device and a control method thereof, so that a user is allowed to plan a desired navigation route to avoid undesired roads or areas through intuitive touches on a navigation device.

To achieve the above and other objects, the navigation device according to the present invention includes a touch unit and a processing unit. The touch unit receives touches made thereon by a user with an object and correspondingly generates a plurality of touch points. The processing unit is electrically connected to the touch unit and uses a start location, a target location, the plurality of touch points, and an electronic map as a basis to generate a navigation route.

In the present invention, the object touches the touch unit by making at least one continuous slide motion on the touch unit.

In the present invention, the processing unit is able to determine whether the object makes more than one continuous touch on the touch unit. If yes, the processing unit defines the touch points generated corresponding to each of the touches as a specific group of touch points, and uses paths separately defined by different groups of touch points as a basis to generate the navigation route that begins from the start location to pass through the paths defined by the groups of touch points and ends at the target location.

Alternatively, the processing unit can analyze a shortest possible distance from the start location via the touch points to the target location, in order to generate the navigation route.

The navigation device according to the present invention further includes a storage unit, a positioning unit and a display unit. The storage unit is electrically connected to the processing unit for storing the electronic map therein; the positioning unit is electrically connected to the processing unit for determining the current location of the navigation device and providing corresponding positioning information; and the display unit is electrically connected to the processing unit for displaying the navigation route and the electronic map. The processing unit uses the positioning information and the navigation route as a basis to enable a dynamic guidance, and controls the display unit to display the navigation route and the electronic map.

To achieve the object of the present invention, the control method of navigation device according to the present invention is applicable to a navigation device including a touch unit and a processing unit, and includes the following steps: using the touch unit to receive touches made thereon by a user with an object and correspondingly generate a plurality of touch points; and the processing unit generating a navigation route based on a start location, a target location, the touch points, and an electronic map.

The navigation device control method further includes a step of using the object to touch the touch unit by making at least one continuous slide motion on the touch unit.

The navigation device control method further includes the following steps: the processing unit determining whether the object makes more than one continuous touch on the touch unit; if yes, the processing unit defining the touch points generated corresponding to each of the touches as a specific group of touch points; and the processing unit using paths separately defined by different groups of touch points as a basis to generate the navigation route that begins from the start location to pass through the paths defined by the groups of touch points and ends at the target location.

The navigation device control method further includes a step of using the processing unit to analyze a shortest possible distance from the start location via the touch points to the target location, in order to generate the navigation route.

The navigation device control method further includes the following steps: using a storage unit to store the electronic map therein; using a positioning unit to determine the current location of the navigation device and provide corresponding positioning information; using a display unit for displaying the navigation route and the electronic map; and the processing unit uses the positioning information and the navigation route as a basis to enable a dynamic guidance and control the display unit to display the navigation route and the electronic map.

To achieve the object of the present invention, the computer program product according to the present invention can be loaded and executed on a computer to implement the navigation device control method according to the present invention.

To achieve the object of the present invention, the program-storing computer-readable storage medium according to the present invention allows the program stored therein to be loaded and executed on a computer to implement the navigation device control method according to the present invention.

In conclusion, with the program-storing computer-readable storage medium, the computer program product, the navigation device and the control method thereof according to the present invention, a user may intuitively touch the touch unit with one finger or a touch pen to roughly plan a desired driving route that passes, for example, a bookstore, a convenience store, a department store, or a road without traffic congestion, and the processing unit will use the start location, the target location, the electronic map, and the touch points generated corresponding to the user's touches on the touch unit as a basis to generate a navigation route that begins from the start location and ends at the target location while passing through roads closest to the paths defined by the user's touch points. Through touching the touch unit by a user in an intuitive manner to plan a preliminary path, the navigation device is able to generate a navigation route that not only satisfies the preliminary path but also avoids undesired roads or areas, such as roads with traffic jam or demonstration parade or mountain areas. Therefore, the intuitively operable navigation device of the present invention is very convenient for use.

### BRIEF DESCRIPTION OF THE DRAWINGS

FIG. 1 is a block diagram of a navigation device according to the present invention;

FIG. 2 schematically shows a first embodiment of the navigation device of the present invention;

FIG. 3 schematically shows a second embodiment of the navigation device of the present invention;

FIG. 4 is a flowchart showing the steps included in a control method of the navigation device of the present invention;

FIG. 5 is another flowchart showing further steps included in the control method of the navigation device of the present invention; and

FIG. 6 is a further flowchart showing still further steps included in the control method of the navigation device of the present invention.

### DETAILED DESCRIPTION

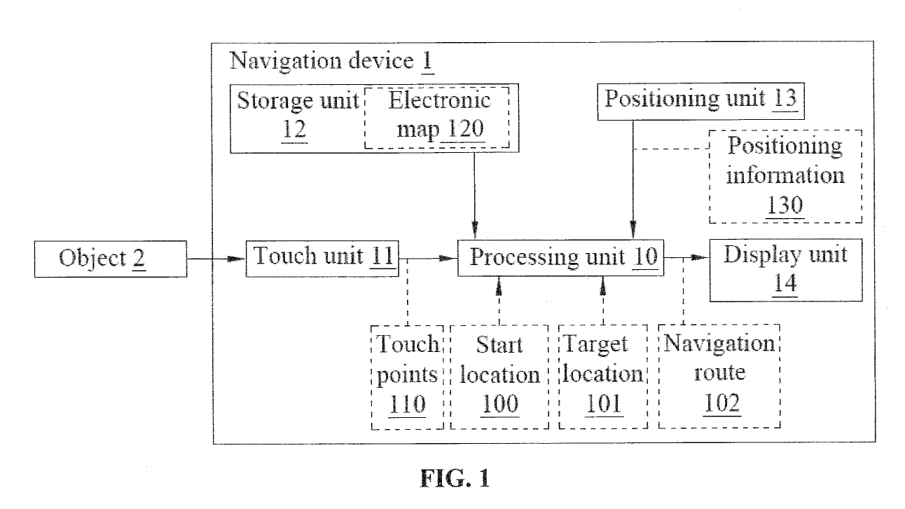

Please refer to FIG. 1 that is a block diagram of a navigation device 1 according to the present invention. As shown, the navigation device 1 includes a processing unit 10, a touch unit 11, a storage unit 12, a positioning unit 13, and a display unit 14. The processing unit 10 is electrically connected to the touch unit 11, the storage unit 12, the positioning unit 13 and the display unit 14. The storage unit 12 can be any one of various currently available storage media, such as an embedded memory, an external memory (card), a disk, or a compact disk (CD), and has at least one electronic map 120 stored therein. In a preferred embodiment, the positioning unit 13 can be a global Positioning System (GPS) for receiving satellite signals and computing a current location of the navigation device 1, and then providing corresponding positioning information 130. The touch unit 11 can be a resistive touch device, a capacitive touch device, an ultrasonic touch device, an optical touch device, or an electromagnetic induction touch device. In the case of an optical touch device, it can be an infrared (IR) touch device. A user can touch the touch unit 11 with an object 2, such as the user's finger or a touch pen. On receiving the touch made by a user with the object 2, the touch unit 11 will correspondingly generate a plurality of touch points 110 as a signal. Thereafter, the processing unit 10 generates a navigation route 102 based on a start location 100, a target location 101, the plurality of touch points 110, and the electronic map 120. Thus, it is able to plan the navigation route 102 that is closest to the user's desired roads and avoid some undesired roads as specified by the user to achieve the purpose of allowing a user to intuitively plan a preliminary path.

In addition, the processing unit 10 further dynamically guides the user based on the positioning information 130 and the navigation route 102 and controls the display unit 14 to display the navigation route 102 and the electronic map 120, so as to achieve the function of dynamic guiding. The processing unit 10 can be a central processing unit (CPU) or a microprocessor.

In using the touch unit 11, the user can use the object 2 to make a continuous slide motion on the touch unit 11 or to make multiple separated point touches on the touch unit 11. In a preferable embodiment, the touch unit 11 is touched with the object 2 in a continuous slide motion. In other words, the user can draw a preliminary path on the touch unit 11, and the processing unit 10 will then use the preliminary path as a basis to plan a navigation route 102 closest thereto.

While the concept of the present invention has been interpreted with one single continuous slide motion on the touch unit, it is understood one of ordinary skill in the art can easily extend the above interpretation for a user to make multiple continuous slide motions on the touch unit to draw more than one preliminary path. For example, a user wants to make stops at a bookstore and a convenience store, which are quite distant from each other, but has only a vague idea about the roads to these two places and therefore fails to plan a complete path to get there. In this case, the user can make two separated continuous slide motions on the touch unit 11, and the processing unit 10 is able to define the touch points 110 corresponding to each of the two continuous slide motions as a first group of touch points and a second group of touch points. Then, based on the path defined by the first group of touch points and the path defined by the second group of touch points, the processing unit 10 generates a navigation route 102 that begins from the start location 100 to pass through the paths defined by the first and the second group of touch points and ends at the target location 101.

According to the above description, the processing unit 10 can either analyze the shortest possible distance from the start location 100 via the plurality of touch points 110 to the target location 101 to generate the navigation route 102, or plan and generate a closest navigation route 102 according to the sequence of and the paths defined by the user's separated touches on the touch unit, allowing a user to conveniently complete an intuitive operation on the navigation device 1 to plan his or her desired driving route.

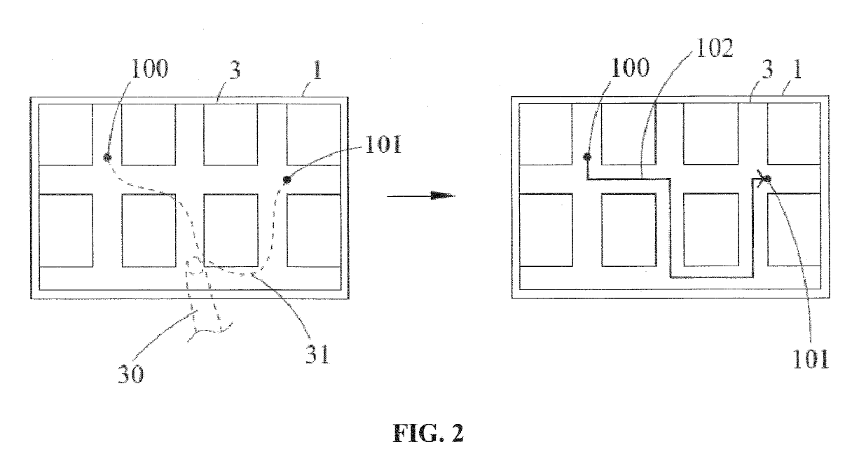

Please refer to FIG. 2 that schematically shows a first embodiment of the navigation device 1 according to the present invention. As shown, in this first embodiment, the touch unit and the display unit are combined into a touch screen 3. The touch screen 3 displays the start location 100 and the target location 101. A user can continuously slide his or her finger 30 on the touch screen 3 to draw a preliminary path 31. Although the preliminary path 31 drawn by the user might extend through a building or some non-road places as shown in the left part of FIG. 2, the processing unit is able to, based on the preliminary path 31, generate a navigation route 102 closest to the preliminary path 31 as shown in the right part of FIG. 2. That is, the navigation device 1 allows the user to intuitively plan a preliminary path on the touch screen 3 and avoid undesired roads, so as to achieve the object of quickly generating an optimal navigation route while avoiding undesired roads.

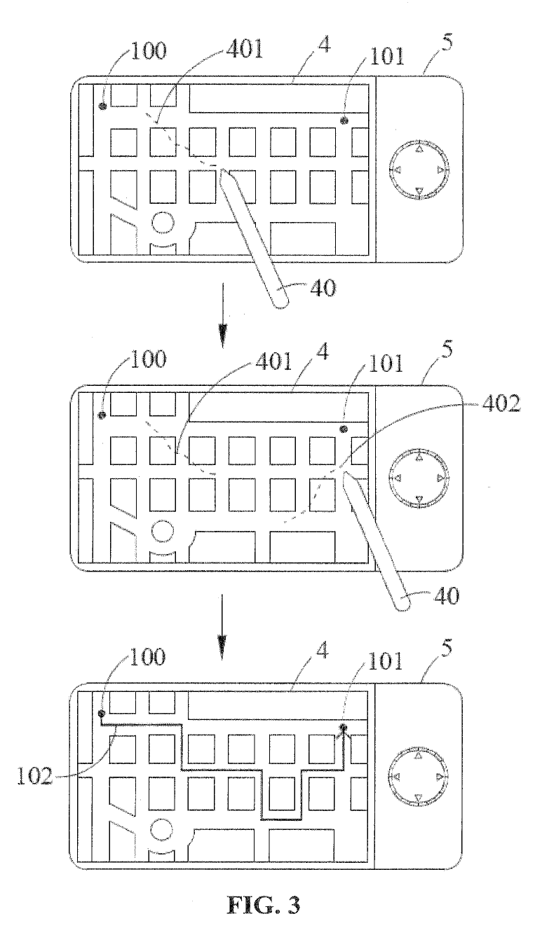

FIG. 3 schematically shows a second embodiment of the navigation device 1 according to the present invention. As shown, the navigation device 1 can be any electronic device 5 capable of displaying the navigation route, such as a notebook computer, a mobile phone, or a personal digital assistant (PDA), depending on what the user thinks as most convenient for him or her to use. In the illustrated second embodiment, the electronic device 5 is a PDA. On the PDA 5, there is a touch screen 4 combining a touch unit and a display unit for displaying an electronic map, receiving touches made by a user with an object, and correspondingly generating a plurality of touch points. In FIG. 3, the touch screen 4 displays an electronic map, and it is supposed the user knows that there is a demonstration parade at the roundabout shown in the electronic map and wants to drive through a road without passing through the zone near the roundabout. Under this condition, the user may continuously slide his or her finger or a touch pen 40 on the touch screen 4 to draw a first preliminary path 401. In the case the user also wants to pass through a certain landmark, such as a bookstore, a department store or a convenience store, when he or she drives through the desired road, the user may once again continuously slide his or her finger or the touch pen 40 on the touch screen 4 to draw a second preliminary path 402. The touch unit will then sequentially generate a first group of touch points and a second group of touch points corresponding to the first and the second slide motions, respectively. That is, the first group of touch points includes a plurality of first touch points, and the second group of touch points includes a plurality of second touch points. Then, the processing unit uses a path defined by the first group of touch points, a path defined by the second group of touch points, the start location 100, the target location 101, and the electronic map as a basis to generate a navigation route 102, and controls the touch screen 4 to display the navigation route 102. The processing unit further uses the positioning information and the navigation route 102 as a basis to enable a dynamic guidance for the user to navigate from the start location 100 to the target location 101 along roads generally similar to the user-planned preliminary paths.

It is noted an algorithm for generating the navigation route 102 may use the start location 100, the first and/or second touch points and the target location 101 as a basis to analyze a shortest possible distance thereof to generate the navigation route 102, or use the sequence of and the paths defined by the user's touches on the touch unit to plan the navigation route 102. In the event the preliminary paths generated according to different groups of touch points overlap with one another, the processing unit will analyze the overlapped portion to generate the optimized navigation route 102. However, in the present invention, there is not any particular limitation to the algorithm for generating the navigation route, and the algorithm can be determined completely depending on the requirement in design.

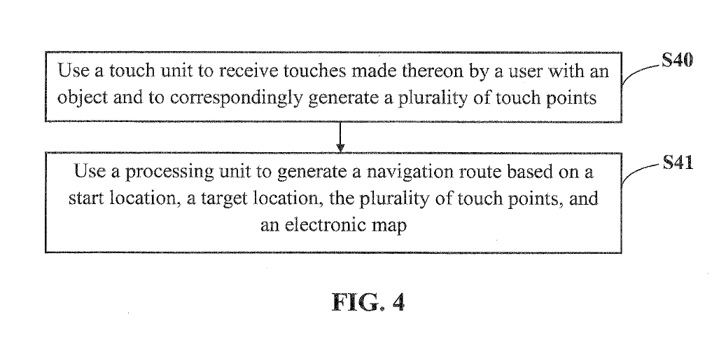

While the above description of the navigation device of the present invention has also described a concept of controlling the navigation device, the following will still give a more detailed description of the navigation device control method with reference to some flowcharts shown in FIGS. 4 to 6.

Please refer to FIG. 4 that is a flowchart showing the steps included in the control method of navigation device according to the present invention. The control method is applicable to a navigation device that includes a touch unit, a storage unit, a processing unit, a positioning unit and a display unit; and the control method includes the following steps:

S40: Use the touch unit to receive touches made thereon by a user with an object and correspondingly generate a plurality of touch points; and

S41: The processing unit generates a navigation route based on a start location, a target location, the plurality of touch points, and an electronic map.

Wherein, the navigation device control method further includes a step of using the object to touch the touch unit by making at least a continuous slide motion on the touch unit. The object can be a touch pen or a user's finger.

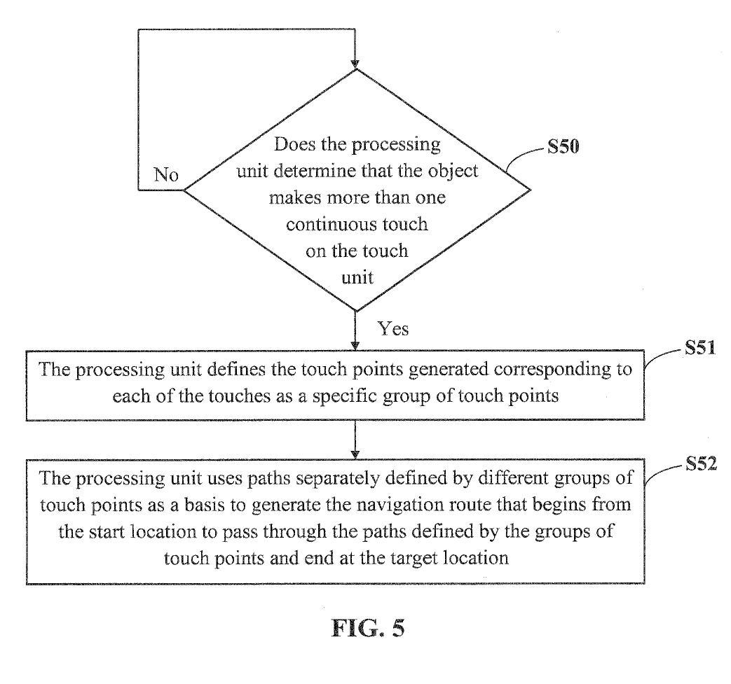

FIG. 5 is another flowchart showing the steps included in the navigation device control method of the present invention. As shown, the navigation device control method of the present invention further includes the following steps:

S50: The processing unit determines whether the object makes more than one continuous slide motion on the touch unit. If yes, go to step S51; or if not, repeat the step S50;

S51: The processing unit defines the touch points generated corresponding to each of the touches as a specific group of touch points; and

S52: The processing unit uses paths separately defined by different groups of touch points to generate a navigation route that begins from the start location to pass through the paths defined by the groups of touch points and ends at the target location.

Wherein, the navigation device control method further includes a step of using the processing unit to analyze a shortest possible distance from the start location via the touch points to the target location, in order to generate the navigation route.

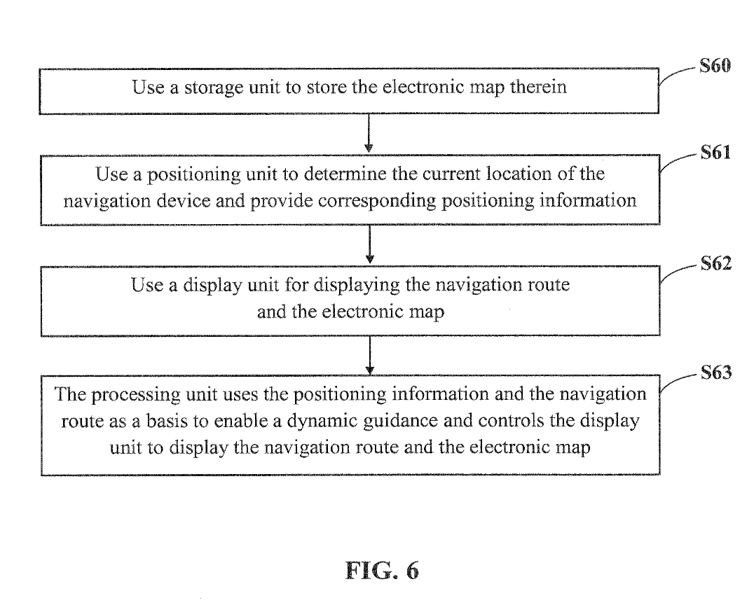

FIG. 6 is a further flowchart showing still further steps included in the navigation device control method of the present invention. As shown, the navigation device control method of the present invention further includes the following steps:

S60: Use the storage unit to store the electronic map therein;

S61: Use the positioning unit to determine the current location of the navigation device and provide corresponding positioning information;

S62: Use the display unit for displaying the navigation route and the electronic map; and

S63: The processing unit uses the positioning information and the navigation route as a basis to enable a dynamic guidance, and controls the display unit to display the navigation route and the electronic map.

Since the implementation of the above steps has already been recited in details in the previous description of the navigation device, it is not repeated herein.

In addition, the present invention also provides a program-storing computer-readable storage medium and a computer program product. A computer for use with the storage medium and the computer program product of the present invention includes, but not limited to, a touch unit, a storage unit, a processing unit, a positioning unit, and a display unit. The storage medium of the present invention can be a compact disk, a hard disk, a flash drive, or other similar storage devices. When the computer loads and executes the program stored in the storage medium or the computer program product, it is able to implement at least the steps S40-S41, S50-S52, and S60-S63 of the navigation device control method as mentioned above.

In conclusion, with the program-storing computer-readable storage medium, the computer program product, the navigation device and the control method thereof according to the present invention, it is able to plan a route that is closest to the paths defined by a plurality of touch points generated according to touches made by a user on the touch unit and accordingly, generate a navigation route beginning from the start location to pass through the paths defined by the touch points and ending at the target location. With the present invention, the user does not need to inconveniently search for avoided roads, such as a jammed road, a freeway, or a road being interrupted by an accident, or to click on an operating window to select an avoidance option, or to block an avoided area on the operating window, which is otherwise required in the case of the conventional navigation devices. That is, the present invention not only provides a function for a user to plan a navigation route through intuitive touches on the touch unit to easily avoid any undesired roads, but also allows the user to plan an idea navigation route that would pass through the user's desired roads or landmarks.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A navigation device, comprising:
a touch unit for receiving touches made thereon by a user with an object and correspondingly generating a plurality of touch points; and
a processing unit being electrically connected to the touch unit and using a start location, a target location, the plurality of touch points, and an electronic map to generate a navigation route.

2. The navigation device as claimed in claim 1, wherein the object touches the touch unit by making at least one continuous slide motion on the touch unit.

3. The navigation device as claimed in claim 2, wherein the processing unit further determines whether the object makes more than one continuous touch on the touch unit; and if yes, the processing unit defines the touch points generated corresponding to each of the touches as a specific group of touch points, and uses paths separately defined by different groups of touch points as a basis to generate the navigation route that begins from the start location to pass through the paths defined by the groups of touch points and ends at the target location.

4. The navigation device as claimed in claim 1, wherein the processing unit analyzes a shortest possible distance from the start location via the touch points to the target location, in order to generate the navigation route.

5. The navigation device as claimed in claim 1, further comprising:
a storage unit being electrically connected to the processing unit for storing the electronic map therein;
a positioning unit being electrically connected to the processing unit for determining a current location of the navigation device and providing corresponding positioning information; and
a display unit being electrically connected to the processing unit for displaying the navigation route and the electronic map;
wherein the processing unit uses the positioning information and the navigation route as a basis to enable a dynamic guidance, and controls the display unit to display the navigation route and the electronic map.

6. A navigation device control method applicable to a navigation device including a touch unit and a processing unit, comprising the following steps:
using the touch unit to receive touches made thereon by a user with an object and correspondingly generate a plurality of touch points; and
using the processing unit to generate a navigation route based on a start location, a target location, the touch points, and an electronic map.

7. The navigation device control method as claimed in claim 6, further comprising a step of using the object to touch the touch unit by making at least one continuous slide motion on the touch unit.

8. The navigation device control method as claimed in claim 7, further comprising the following steps:
the processing unit determining whether the object makes more than one continuous touch on the touch unit;
if yes, the processing unit defining the touch points generated corresponding to each of the touches as a specific group of touch points; and
the processing unit using paths separately defined by different groups of touch points as a basis to generate the navigation route that begins from the start location to pass through the paths defined by the groups of touch points and end at the target location.

9. The navigation device control method as claimed in claim 6, further comprising a step of using the processing unit to analyze a shortest possible distance from the start location via the touch points to the target location, in order to generate the navigation route.

10. The navigation device control method as claimed in claim 6, further comprising the following steps:
using a storage unit to store the electronic map therein;
using a positioning unit to determine a current location of the navigation device and provide corresponding positioning information;
using a display unit for displaying the navigation route and the electronic map; and
the processing unit using the positioning information and the navigation route as a basis to enable a dynamic guidance and controlling the display unit to display the navigation route and the electronic map.

11. A program-storing computer-readable storage medium, wherein the storage medium allows a computer to load and execute the program stored therein to thereby implement the navigation device control method as claimed in claim 6.

12. A program-storing computer-readable storage medium, wherein the storage medium allows a computer to load and execute the program stored therein to thereby implement the navigation device control method as claimed in claim 7.

13. A program-storing computer-readable storage medium, wherein the storage medium allows a computer to load and execute the program stored therein to thereby implement the navigation device control method as claimed in claim 8.

14. A program-storing computer-readable storage medium, wherein the storage medium allows a computer to load and execute the program stored therein to thereby implement the navigation device control method as claimed in claim 9.

15. A program-storing computer-readable storage medium, wherein the storage medium allows a computer to load and execute the program stored therein to thereby implement the navigation device control method as claimed in claim 10.

16. A computer program product, wherein the program product is loaded and executed on a computer to thereby implement the navigation device control method as claimed in claim 6.

17. A computer program product, wherein the program product is loaded and executed on a computer to thereby implement the navigation device control method as claimed in claim 7.

18. A computer program product, wherein the program product is loaded and executed on a computer to thereby implement the navigation device control method as claimed in claim 8.

19. A computer program product, wherein the program product is loaded and executed on a computer to thereby implement the navigation device control method as claimed in claim 9.

20. A computer program product, wherein the program product is loaded and executed on a computer to thereby implement the navigation device control method as claimed in claim 10.
